(19) United States
(12) Patent Application Publication
(10) Pub. No.: US 2004/0030811 A1
(43) Pub. Date: Feb. 12, 2004

(54) Method for switching input devices between an input mode and a serial use mode

(75) Inventor: Sheng-Hung Liu, Taipei (TW)

Correspondence Address: BROWDY AND NEIMARK, P.L.L.C., 624 NINTH STREET, NW, SUITE 300, WASHINGTON, DC, 20001-5303, US

(73) Assignee: Jess-Link Products Co., Ltd., Taipei (TW)

(21) Appl. No.: 10/212,125

(22) Filed: Aug. 6, 2002

(51) Int. Cl. G06F 3/00

(52) U.S. Cl. 710/14

(57) ABSTRACT

A method for switching input devices between an input mode and a serial use mode is provided. The method includes steps of: (a) activating software installed in the input device; (b) determining the number lock key status and detecting which key is pressed; and (c) if the number lock key status is “ON” and the pressed key is one of the numeric keys, a first scan code is transmitted to the computer, if the pressed key is not one of the numeric keys, a second scan code is transmitted, if the number lock key status is “OFF” and the pressed key is one of the direction function keys, a third scan code is transmitted to the computer, and if the pressed key is not one of the direction function keys, a fourth scan code is transmitted.

### BACKGROUND OF THE INVENTION

1. Field of the Invention

The present invention relates to a method for switching input devices between an input mode and a serial use mode, and in particular, a method for switching input devices between an input mode and a serial use mode, in which the input devices are serially connected to each other and to a keyboard with a universal serial bus (USB) connector, and each of the input devices only records its own input status.

2. Description of the Prior Art

Input devices such as a keyboard for portable computers are known in the art. Generally, a notebook keyboard includes a plurality of typing keys, function keys, and/or control keys. Unlike a typical desktop computer keyboard, the notebook keyboard doesn't include a separate numeric keypad due to the size limitation thereof. When a user needs to input numerals, he or she has to press a number lock key to switch some of the typing keys into a numerical key mode. After finishing the input of the numerals, the user has to hit the number lock key again to switch these special keys back into their original letter-input mode. Thus, it is believed that the above-mentioned mode input switching is inefficient for computer users.

A conventional subsidiary numeric keypad is developed to solve the above-mentioned problem. The subsidiary numeric keypad is basically an extension of the notebook keyboard. Its purpose is to provide the computer users with a familiar input area for inputting numerals without the need of switching.

However, the number lock key on the subsidiary numeric keypad interferes with the number lock key on the notebook keyboard. This is because they send the same key code to the computer, and thus the same key code results in the synchronic interference. When the status of the subsidiary numeric keypad is “ON” and the numeric key mode of the notebook keyboard is also “ON,” all typing keys of the notebook keyboard and subsidiary keyboard are ready for the numeral inputting, it inevitably affects the computer user and often leads to work interruption. It is known in the art that the subsidiary numeric keypad is inconvenient also.

An approach to improve the problem encountered above is to peremptorily change the typing keys of notebook keyboard to a non-numeric key mode, i.e., the letter-input mode, while the status of the subsidiary numeric keypad is “ON.” In this way, when the user hits any key of the subsidiary numeric keypad, a number lock code is immediately sent to the notebook computer to switch the status of the notebook keyboard typing keys to “ON,” then sends the corresponding key code thereof to the computer. After that, another number lock code is sent to the notebook for the sake of switching the status of the notebook keyboard typing keys to the status of “OFF.” That is, the status of the keyboard of the notebook becomes temporary “ON” only when one presses any key of the subsidiary numeric keypad. When the status of number lock of the subsidiary numeric keypad is “OFF,” the status of the keyboard of the notebook is also “OFF”. In this case, they can use same key code without the need of sending other codes to the computer.

Nevertheless, the subsidiary numeric keypad is defective since that once the number lock key of the notebook keyboard is rendered “OFF,” some key functions involving with the number lock key will not work until the number lock key is “ON” again.

### SUMMARY OF THE INVENTION

The main objective of the invention is to provide an improved method for switching input devices between an input mode and a serial use mode to solve the prior art problem.

In accordance with the present invention, a method for switching input devices between an input mode and a serial use mode is provided. The input devices are serially connected to each other and further to a keyboard with a universal serial bus (USB) connector, and each of the input devices only records its own input status. The method includes steps as follows:

(a) activating software installed in the input device;

(b) determining the status of number lock key and detecting which key is pressed; and

(c) if status of the number lock key is “ON” and the pressed key is one of the numeric keys, a corresponding first scan code is transmitted to the computer, if the pressed key is not one of the numeric keys, a second scan code is transmitted to the computer, if status of the number lock key is “OFF” and the pressed key is one of the direction function keys, a third scan code corresponding to the pressed function key is transmitted to the computer, and if the pressed key is not one of the direction function keys, a fourth scan code of the input device is transmitted to the computer.

Other objectives, advantages, and novel features of the invention will become more clearly and readily apparent from the following detailed description when taken in conjunction with the accompanying drawings.

### BRIEF DESCRIPTION OF THE DRAWING

FIG. 1 is a control flowchart according to the present invention.

### DETAILED DESCRIPTION OF THE PREFERRED EMBODIMENT

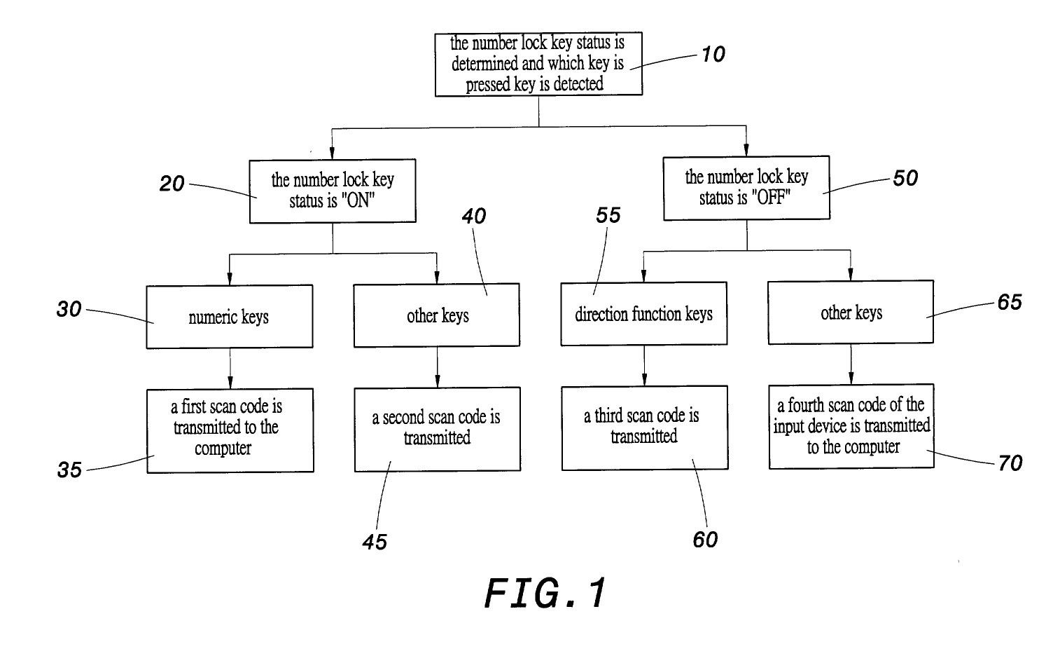

Please refer to FIG. 1. The present invention is directed to a method for switching a keypad between an input mode and a serially use mode. A keyboard with a universal serial bus (USB) connector is provided. An input device, such as a keypad, that is installed with the proper software is connected to the USB connector of the keyboard. The keyboard is suited for the use of a desktop computer or a notebook. The input device is serially connected and will not affect the keyboard in any circumstance. The input device only records its own input status and doesn't record the status of another input device or the keyboard of the notebook.

The method for switching the input device according to the present invention includes following steps. First, the software installed in the input device is activated. Next, the number lock key status is determined and which key is pressed will be detected, as shown as step 10.

If the number lock key status is “ON” and the pressed key is one of the numeric keys (0-9 and “.”) like the steps 20 and 30, a first scan code corresponding to the pressed numeric key of the keyboard is transmitted to the computer, as shown in step 35. If the pressed key is not one of the numeric keys, a second scan code from the input device is transmitted to the computer like steps 40 and 45.

If status of the number lock key is “OFF” as shown in step 50, and the pressed key is one of the direction function keys, such as “→”, “↑”, “←”, “↓”, “Home”, “End”, “PgUp”, “PgDn”, “Ins”, or “Del,” as shown as in step 55, a third scan code corresponding to the pressed function key is transmitted to the computer, as shown in step 60. If the pressed key is not one of the direction function keys as shown in step 65, a fourth scan code of the input device is transmitted to the computer, as shown in step 70.

In this way, the interference between the input device and the keyboard of a notebook is avoided.

It is noted that the initial status of both of the input device and the keyboard of a notebook when the user operates the keyboard with the input device is very important. That is, knowing the status of both of the input device and the keyboard of a notebook helps the users how to use the system more properly. When using the input device, there are two points to be understood as follows.

1. Before activating the computer, if the input device has been connected to the computer, then the initial number lock key status of the input device is “ON” after the computer is activated.

2. Before booting the computer, if the input device is not connected to the computer, then the initial number lock key status of the input device is also “ON” after the computer is activated.

Furthermore, according to this invention, optionally, a lighting device can be installed in the number lock key of the input device to correctly indicate the number lock key status of the input device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for switching input devices between an input mode and a serial use mode, the input devices being serially connected to each other and further connected to a keyboard with a universal serial bus (USB) connector, each of the input devices only recording an input status thereof, the method comprising:
(a) activating software installed in the input device;
(b) determining a number lock key status of the input device and detecting which key of the input device is pressed; and
(c) if the number lock key status is “ON” and the key pressed is one of the numeric keys, a corresponding first scan code is transmitted to a computer, if the key pressed is not one of the numeric keys, a second scan code for the input device is transmitted to the computer, if the number lock key status is “OFF” and the key pressed is one of the direction function keys, a corresponding third scan code is transmitted to the computer, and if the pressed key is not one of the direction function keys, a fourth scan code of the input device is transmitted to the computer.
whereby interferences between the input device and the keyboard are avoided.

2. The method as claimed in claim 1 wherein the keyboard is used for a desktop computer or a notebook.

3. The method as claimed in claim 1 wherein the input device is a numeric keypad.

4. The method as claimed in claim 1 wherein if the input device has been connected to the computer before the computer is activated, then the initial number lock key status of the input device is “ON” after the computer is activated.

5. The method as claimed in claim 1 wherein if the input device was not connected to the computer before the computer is activated, then the initial number lock key status of the input device is also “ON” after the computer is activated.

6. The method as claimed in claim 1 wherein if the number lock key is “ON” means that the input device is for numeral inputting.

7. The method as claimed in claim 1 further having installed a lighting device to the number lock key of the input device for indicating the number lock key status of the input device.
